(19) United States
(12) Patent Application Publication
(10) Pub. No.: US 2023/0004255 A1
(43) Pub. Date: Jan. 5, 2023

(54) SYSTEMS AND METHODS FOR INTERACTING WITH A USER INTERFACE OF AN ELECTRONIC DEVICE

(71) Applicant: NNAK Pty Ltd., Doreen (AU)

(72) Inventor: Kaveh Moghaddam Tabrizi, Doreen (AU)

(21) Appl. No.: 17/852,147

(22) Filed: Jun. 28, 2022

(30) Foreign Application Priority Data
Jul. 2, 2021 (AU) 2021902017

(51) Int. Cl. G06F 3/042; G06F 3/01; G06V 40/18

(52) U.S. Cl. CPC G06F 3/0421; G06F 3/013; G06V 40/18

(57) ABSTRACT

Systems and methods for interacting with a user interface of an electronic device are disclosed herein. A system according to one aspect comprises an image recording device fixed in relation to the electronic device and configured to generate image data of an image area spaced from the user interface; an infrared device fixed in relation to the electronic device and configured to generate infrared data of an infrared area spaced from the user interface; and a controller operatively connected to the infrared device and the image recording device.

### TECHNICAL FIELD

The present disclosure relates to methods and systems for interacting with a user interface of an electronic device.

### BACKGROUND

Touch user interfaces are used with a range of electronic devices, such as computers, for enhancing user interaction therewith. For example, in the services industry, touch user interfaces are used with self-service kiosks, point-of-sale devices, self-checkout devices, EFTPOS devices, vending machines and advertising displays. In the banking industry, touch user interfaces are widely used with automated teller machines (ATM). In the medical industry, touch user interfaces are also used with telehealth devices and medical devices or instruments, such as dialysis machines and medical imaging devices. Such devices typically operate in busy environments and are used by multiple users.

A disadvantage of touch user interfaces is that germs and other causes of infection, such as bacteria, viruses or other harmful organisms, may be placed on the surface of the touch user interfaces. Subsequent users may inadvertently become contaminated with such germs and viruses when using the touch user interface. Contaminated users may then transmit the germs and viruses to other persons, thus causing harm to those persons. Similarly, user interfaces in the form of public control buttons, such as pedestrian crossing push buttons, elevator push buttons and keypads of non-touch interfacing ATMs, are used by multiple users and may also become contaminated by germs and viruses during user contact with the control buttons.

Apart from the public health risks posed by the spread of germs and viruses, such user interfaces may also be vulnerable to security threats, particularly in circumstances where a user is required to input a security pin or password using the user interfaces. For example, users may leave marks or fingerprints on the surface of such user interfaces which may be exploited by would-be perpetrators.

Object

It is an object of the present disclosure to substantially overcome or ameliorate one or more of the above disadvantages, or at least provide a useful alternative.

### SUMMARY

In accordance with an aspect of the present disclosure, there is provided a system for interacting with a user interface of an electronic device, the system comprising:

an image recording device fixed in relation to the electronic device and configured to generate image data of an image area spaced from the user interface;

an infrared device fixed in relation to the electronic device and configured to generate infrared data of an infrared area spaced from the user interface; and

a controller operatively connected to the infrared device and the image recording device, the controller configured to:
detect at least a portion of a finger of a person in the infrared area based on the infrared data;
in response to the detection of the portion of the finger, determine the position of the portion of the finger in relation to the infrared device based on the infrared data;
detect at least an eye of the person in the image area based on the image data;
in response to the detection of the eye of the person, determine the position of the eye in relation to the image recording device based on the image data; and
determine a desired point on the user interface based on the position of the portion of the finger and the position of the eye; and
generate an instruction to interact with the user interface based on the desired point.

The controller may be configured to determine the position of the portion of the finger by:

calculating a pixel coordinate of a point of the portion of the finger based on the infrared data; and

calculating the position of the portion of the finger based on the pixel coordinate of the point of the portion of the finger.

The controller may be configured to determine the position of the one eye by:

calculating a pixel coordinate of a central point of the one eye; and

calculating the position of the one eye based on the pixel coordinate of the central point of the one eye.

The controller may be configured to determine a desired point on the user interface by:

calculating a position on the user interface based on the position of the portion of the finger and the position of the one eye; and

calculating the desired point, in the form of a pixel coordinate, on the user interface based on the position on the user interface.

The controller may be configured to determine the position of the two eyes by:

calculating a pixel coordinate of a central point between the two eyes; and

calculating the position of the two eyes based on the pixel coordinate of the central point of the two eyes.

The controller may be configured to determine a desired point on the user interface by:

calculating a position on the user interface based on the position of the portion of the finger and the position of the two eyes; and

calculating the desired point, in the form of a pixel coordinate, on the user interface based on the position on the user interface.

The image recording device may be a camera.

The infrared device may be an infrared touch frame.

In accordance with another aspect of the present disclosure, there is provided a method of interacting with a user interface of an electronic device, the method comprising:

detecting at least a portion of a finger of a person in an infrared area spaced from the user interface, based on infrared data generated by an infrared device;

in response to the detection of the portion of the finger, determining the position of the portion of the finger in relation to the infrared device based on the infrared data;

detecting at least an eye of the person in an image area spaced from the user interface, based on image data generated by an image recording device;

in response to the detection of the eye of the person, determining the position of the eye in relation to the image recording device based on the image data;

determining a desired point on the user interface based on the position of the portion of the finger and the position of the eye; and

generating an instruction to interact with the user interface based on the desired point.

Determining the position of the portion of the finger may comprise:

calculating a pixel coordinate of a point of the portion of the finger based on the infrared data; and

calculating the position of the portion of the finger based on the pixel coordinate of the point of the portion of the finger.

Determining the position of the one eye may comprise:

calculating a pixel coordinate of a central point of the one eye; and

calculating the position of the one eye based on the pixel coordinate of the central point of the one eye.

Determining a desired point on the user interface may comprise:

calculating a position on the user interface based on the position of the portion of the finger and the position of the one eye; and

calculating the desired point, in the form of a pixel coordinate, on the user interface based on the position on the user interface.

Determining the position of the two eyes may comprise:

calculating a pixel coordinate of a central point between the two eyes; and

calculating the position of the two eyes based on the pixel coordinate of the central point of the two eyes.

Determining a desired point on the user interface may comprise:

calculating a position on the user interface based on the position of the portion of the finger and the position of the two eyes; and

calculating the desired point, in the form of a pixel coordinate, on the user interface based on the position on the user interface.

In accordance with a further aspect of the present disclosure, there is provided a system for interacting with a user interface of an electronic device, the system comprising:

a first infrared device fixed in relation to the electronic device and configured to generate first infrared data of a first infrared area spaced from the user interface;

a second infrared device fixed in relation to the electronic device and configured to generate second infrared data of a second infrared area spaced from the user interface and the first infrared area; and

a controller operatively connected to the first infrared device and the second infrared device, the controller configured to:
detect a first portion of a finger of a person in the first infrared area based on the first infrared data;
in response to the detection of the first portion of the finger, determine the position of the first portion of the finger in relation to the first infrared device based on the first infrared data;
detect a second portion of the finger in the second infrared area based on the second infrared data;
in response to the detection of the second portion of the finger, determine the position of the second portion of the finger in relation to the second infrared device based on the second infrared data;
determine a desired point on the user interface based on the position of the first portion of the finger and the position of the second portion of the finger; and
generate an instruction to interact with the user interface based on the desired point.

The controller may be configured to determine the position of the first portion of the finger by:

calculating a pixel coordinate of a point of the first portion of the finger based on the infrared data; and

calculating the position of the first portion of the finger based on the pixel coordinate of the point of the first portion of the finger.

The controller may be configured to determine the position of the second portion of the finger by:

calculating a pixel coordinate of a point of the second portion of the finger based on the infrared data; and

calculating the position of the second portion of the finger based on the pixel coordinate of the point of the second portion of the finger.

The controller may be configured to determine a desired point on the user interface by:

calculating a position on the user interface based on the position of the first portion of the finger and the position of the second portion of the finger; and

calculating the desired point, in the form of a pixel coordinate, on the user interface based on the position on the user interface.

Each of the first and second infrared devices may be an infrared touch frame.

In accordance with another aspect of the present disclosure, there is provided a method of interacting with a user interface of an electronic device, the method comprising:

detecting a first portion of a finger of a person in a first infrared area spaced from the user interface, based on infrared data generated by a first infrared device;

in response to the detection of the first portion of the finger, determining the position of the first portion of the finger in relation to the first infrared device based on the first infrared data;

detecting a second portion of a finger of a person in a second infrared area spaced from the user interface and the first infrared area, based on second infrared data generated by a second infrared device;

in response to the detection of the second portion of the finger, determining the position of the second portion of the finger in relation to the second infrared device based on the second infrared data;

determining a desired point on the user interface based on the position of the first portion and the position of the second portion; and

generating an instruction to interact with the user interface based on the desired point.

### BRIEF DESCRIPTION OF DRAWINGS

Embodiments of the present disclosure will now be described hereinafter, by way of examples only, with reference to the accompanying drawings, in which:

FIG. 1 is a perspective view of an embodiment of a system fixedly attached to an electronic device in the form of a computer;

FIG. 2 is a schematic illustration of the system of FIG. 1 operatively connected to the electronic device;

FIG. 3 is a flow diagram of an embodiment of a method of interacting with a user interface of the electronic device using the system of FIG. 1;

FIG. 4 is a perspective view of another embodiment of a system fixedly attached to an electronic device in the form of a computer;

FIG. 5 is a schematic illustration of the system of FIG. 4 operatively connected to the electronic device;

FIG. 6 is a flow diagram of an embodiment of a method of interacting with a user interface of the electronic device using the system of FIG. 4;

FIG. 7 is a schematic illustration of another embodiment of a system operatively connected to an electronic device;

FIG. 8 is a flow diagram of an embodiment of a method of interacting with a user interface of the electronic device using the system of FIG. 7;

FIG. 9 is a perspective view of another embodiment of a system connected to an elevator push button;

FIG. 10 is a perspective view of another embodiment of a system connected to an ATM keypad; and

FIG. 11 is a perspective view of the system of FIG. 10, without the infrared device.

### DESCRIPTION OF EMBODIMENTS

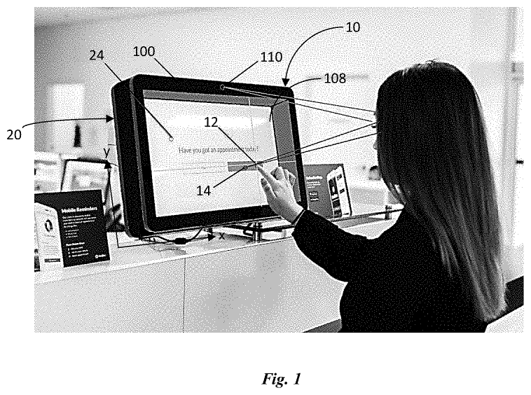

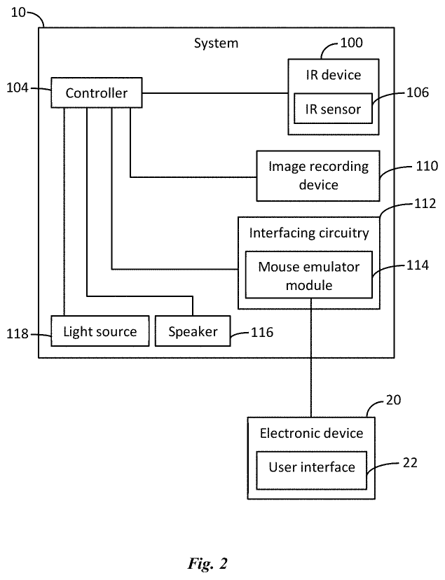

FIGS. 1 and 2 show an embodiment of a system 10 for interacting with a user interface 22 of an electronic device 20. In this embodiment, the electronic device 20 is in the form of a computer with a forwardly-facing touch screen display 24. The display 24 is substantially planar and has a maximum width W_{M} along the x-axis and a maximum height H_{M} along the y-axis. Further, in this embodiment, the display 24 has a maximum resolution (X_{MAX}, Y_{MAX}) and the user interface 22 is the display 24 showing a graphical user interface thereon. It will be appreciated that a user will be able to interact with the graphical user interface by physically pressing on a desired point on the display 24.

The system 10 comprises an infrared (IR) device 100 in the form of an IR touch frame. The IR device 100 is configured to be fixedly attached to the electronic device 20 so as to be disposed in front of the display 24 and not obscure the display 24 when viewed from the front.

The IR device 100 comprises an IR sensor 106 with a set of IR transmitters and receivers. The IR sensor 106 is configured to generate IR data of a pre-defined two-dimensional IR area 108 with a boundary defined by the IR device 100. The IR area 108 has a maximum width W_{S1} along the x-axis and a maximum height H_{S1} along the y-axis. In this embodiment, the width W_{S1} and the height H_{S1} are substantially the same as the width W_{M} and the height H_{M} of the display 24, respectively. The IR area 108 also has a maximum resolution (X_{S1,MAX}, Y_{S1,MAX}). The IR area 108 is spaced from the display 24 at a pre-defined distance D and is substantially parallel thereto when the IR device 100 is attached to the electronic device 20.

Further, the system 10 comprises an image recording device 110 attached to the IR device 100. In this embodiment, the image recording device 110 is in the form of a camera. The image recording device 110 is configured to generate image data of a pre-defined image area spaced forwardly of the user interface 22 and forwardly of the IR area 108 such that the IR area 108 is disposed between the image area and the display 24. The image recording device 110 has an angle of view that defines a maximum width W_{E} along the x-axis and a maximum height H_{E} along the y-axis. The image data generated by the image recording device 110 includes two-dimensional images. Each image has a maximum resolution (X_{E.MAX}, Y_{E.MAX}).

The system 10 further comprises a controller 104 mounted to the IR device 100 and operatively connected to the IR device 100 and the image recording device 110. The controller 104 is configured to control various functions of the system 10 and may be in the form of a microcontroller, for example, having a processor and a memory. The memory is configured to store information and/or instructions for directing the processor. The processor is configured to execute instructions, such as those stored in the memory. In this embodiment, the microcontroller is an ARM11 microcontroller.

In other embodiments, the microcontroller may have a storage device, such as a Hard Disk Drive (HDD).

The system 10 also comprises an interfacing circuitry 112 operatively connected to the controller 104 and is configured to allow communication between the electronic device 20 and the controller 104. In this embodiment, the interfacing circuitry 112 includes a USB connector (not shown) configured to be connected to a USB port of the electronic device 20 for data transmission therebetween. In some embodiments, the interfacing circuitry 112 may also be configured to receive, via the USB connector, power from the electronic device 20 to power electronic components of the system 10. Moreover, the interfacing circuitry 112 comprises a mouse emulator module 114 for routing instructions from the controller 104 to the electronic device 20.

In alternative embodiments, the interfacing circuitry 112 may be wirelessly connected to the electronic device 20 by any wireless technology such as, for example, Bluetooth, Near-Field Communication (NFC), Radio-Frequency Identification (RFID), or Wi-Fi.

The system 10 also comprises one or more speakers 116 and one or more light sources 118 operatively connected to the controller 104. In this embodiment, the one or more light sources 118 comprises an LED array.

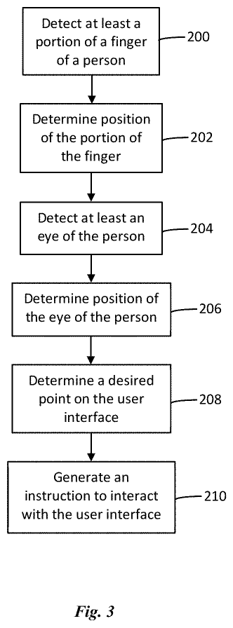

With reference to FIG. 3, the controller 104 of the system 10 is configured to execute instructions to carry out the method operations described hereinafter. The method operations are commenced only when the USB connector of the interfacing circuitry 112 is connected to the USB port of the electronic device 20. It will also be appreciated that the IR device 100 and the image recording device 110 will be fixed in relation to the electronic device 20 when the IR device 100 is attached to the electronic device 20.

The method begins at step 200 of FIG. 3, in which the controller 104 detects at least a portion 12 of a finger of a person in the IR area 108 (see also FIG. 1) based on the IR data. In this regard, the controller 104 periodically obtains IR data from the IR sensor 106 and the IR data is recorded and stored in the memory. Additionally or optionally, the controller 104 may control the speaker 116 to produce a sound and/or the light source 118 to illuminate upon detection of the first portion 32 of the finger in the IR area 108. The controller 104 then determines a pixel coordinate (PosX_{S1}, PosY_{S1}) of the location of the portion 12 of the finger in the IR area 108 based on the IR data. In some embodiments, the pixel coordinate (PosX_{S1}, PosY_{S1}) may be indicative of a central point of the portion 12 of the finger in the IR area 108. In other embodiments, the pixel coordinate (PosX_{S1}, PosY_{S1}) may be indicative of any point of the portion 12 of the finger in the IR area 108.

In response to the detection of the portion 12 of the finger in the IR area 108, the controller 104 then determines at step 202 of FIG. 3 the position (X_{S1}, Y_{S1}) of the portion 12 of the finger in relation to the IR device 100, based on the pixel coordinate (PosX_{S1}, PosY_{S1}) derived from the IR data. In this embodiment, the position (X_{S1}, Y_{S1}) of the portion 12 of the finger is calculated as follows:

$${X}_{s 1} = \frac{{W}_{s 1}}{{X}_{S 1 . MAX}} ( {X}_{S 1 . MAX} - {PosX}_{S 1} ) \qquad ( 1 )$$

$${Y}_{s 1} = \frac{{H}_{s 1}}{{Y}_{S 1 . MAX}} ( {Y}_{S 1 . MAX} - {PosY}_{S 1} ) \qquad ( 2 )$$

At step 204 of FIG. 3, the controller 104 then detects at least an eye of the person in the image area (see also FIG. 1) based on the image data. In this regard, the controller 104 periodically obtains image data from the image recording device 110 and the image data is recorded and stored in the memory. The controller 104 identifies the eye of the person in the obtained image data through known methods including, for example, neural network image processing and fuzzy classification algorithms. The controller 104 determines a pixel coordinate (PosX_{E}, PosY_{E}) of the location of the eye in the image area based on the obtained image data. In some embodiments, the pixel coordinate (PosX_{E}, PosY_{E}) may be indicative of a central point of the eye in the image area. In other embodiments, the controller 104 may detect both eyes of the person in the image area and the pixel coordinate (PosX_{E}, PosY_{E}) may be indicative of a central point between the eyes of the person. In further embodiments, the controller 104 may determine an average position of the eyes using facial recognition algorithms.

In response to the detection of the eye of the person, the controller 104 determines at step 206 of FIG. 3 the position of the eye in relation to the image recording device 110, based on the pixel coordinate (PosX_{E}, PosY_{E}) derived from the image data. In this embodiment, the position (X_{E}, Y_{E}) of the eye is calculated as follows:

$${X}_{E} = {W}_{E} ( 1 - \frac{{PosX}_{E}}{{X}_{E . MAX}} ) \qquad ( 3 )$$

$${Y}_{E} = {H}_{E} ( 1 - \frac{{PosY}_{E}}{{Y}_{E . MAX}} ) \qquad ( 4 )$$

Subsequently, at step 208 of FIG. 3, the controller 104 determines a desired point 14 on the graphical user interface shown on the display 24 (see also FIG. 1). The desired point 14 is the point on the graphical user interface of the display 24 that the user is pointing to. In this embodiment, the controller 104 determines the desired point 14 by first calculating a position (X, Y) on the display 24 based on the position (X_{S1}, Y_{S1}) of the portion 12 of the finger and the position (X_{E}, Y_{E}) of the eye, as follows:

$$X = \frac{{X}_{S 1} ( D + Z ) - {DX}_{E}}{Z} \qquad ( 5 )$$

$$Y = \frac{{Y}_{S 1} ( D + Z ) - {DY}_{E}}{Z} \qquad ( 6 )$$

where:

Z is the distance between the eye of the person and the IR area 108 and is determined using known face detection algorithms, which estimates the apparent size of the eye of the person.

The controller 104 then calculates a desired point position (PosX, PosY) of the desired point 14 on the graphical user interface of the display 24, in the form of a pixel coordinate, based on the position (X, Y), as follows:

$$PosX = {X}_{MAX} ( 1 - \frac{X}{{W}_{M}} ) \qquad ( 7 )$$

$$PosY = {X}_{MAX} ( 1 - \frac{Y}{{H}_{M}} ) \qquad ( 8 )$$

At step 210 of FIG. 3, the controller 104 then generates an instruction signal based on the desired point position (PosX, PosY) of the desired point 14 and transmits the instruction signal to the electronic device 20, via the mouse emulator module 114 of the interfacing circuitry 112, to interact with the user interface 22 such that the desired point 14 is emulated on the graphical user interface. It will be appreciated that the electronic device 20 will emulate the desired point 14 on the graphical user interface through known methods based on the instruction signal received from the controller 104.

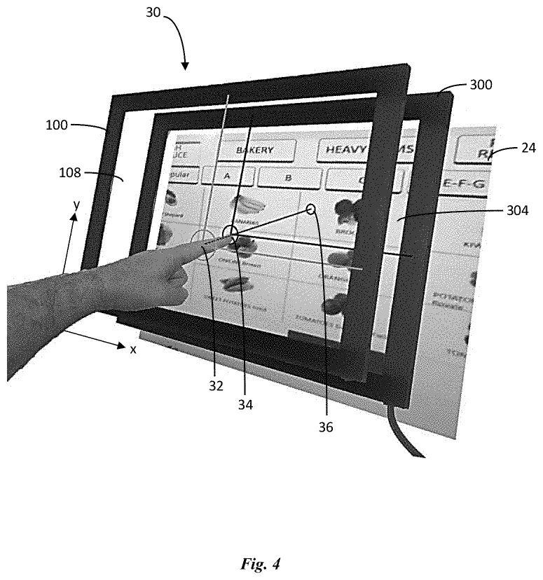

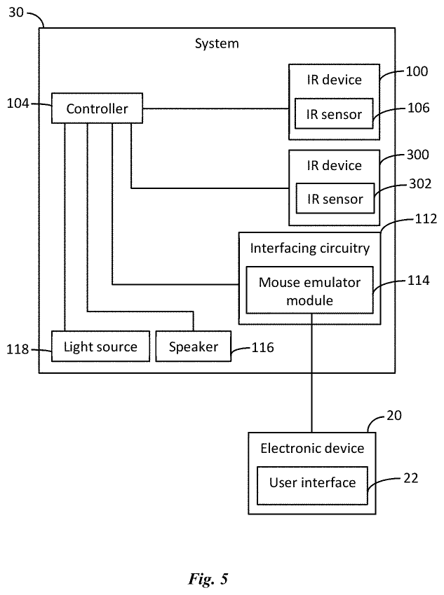

FIG. 4 shows another embodiment of a system 30 for interacting with a user interface 22 of an electronic device 20. The system 30 is substantially similar to the system 10 and like features have been indicated with like reference numerals. However, in this embodiment, the system 30 comprises a further IR device 300 in place of an image recording device. The IR device 300 is in the form of an IR touch frame attached to the IR device 100 and disposed rearwardly thereof. The IR device 300 is configured to be fixedly attached to the electronic device 20 so as to not obscure the display 24 when viewed from the front. It will be appreciated that in other embodiments the IR device 300 may be disposed forwardly of the IR device 100 and the IR device 100 may be configured to be fixedly attached to the electronic device 20 so as to not obscure the display 24 when viewed from the front.

The IR device 300 is operatively connected to the controller 104 and comprises an IR sensor 302 with a set of IR transmitters and receivers. The IR sensor 302 is configured to generate IR data of a pre-defined two-dimensional IR area 304 with a boundary defined by the IR device 300. The IR area has a maximum width W_{S2} along the x-axis and a maximum height H_{S2} along the y-axis that are substantially the same as the width W_{M} and the height H_{M} of the display 24, respectively. The IR area 304 also has a maximum resolution (X_{S2.MAX}, Y_{S2.MAX}) that is substantially the same as the maximum resolution (X_{S1.MAX}, Y_{S1.MAX}) of the IR area 108. The IR area 304 is spaced from the display 24 at a pre-defined distance Dₘ and is substantially parallel thereto when the IR device 300 is attached to the electronic device 20. The IR area 304 is also spaced from the IR area 108 at a pre-defined distance D_{f}.

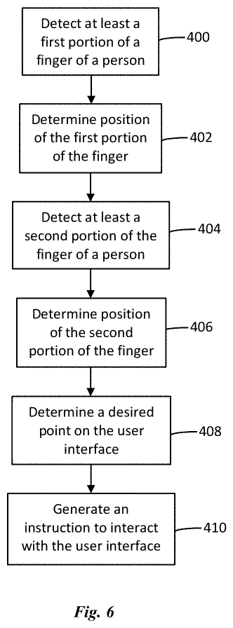

With reference to FIG. 6, the controller 104 of the system 30 is configured to execute instructions to carry out the method operations described hereinafter. The method operations are commenced only when the USB connector of the interfacing circuitry 112 is connected to the USB port of the electronic device 20. It will also be appreciated that the IR devices 100, 300 will be fixed in relation to the electronic device 20 when the IR devices 100, 300 are attached to the electronic device 20.

The method begins at step 400 of FIG. 6, in which the controller 104 detects at least a first portion 32 of a finger of a person in the IR area 108 (see also FIG. 4) based on the IR data. In this regard, the controller 104 periodically obtains IR data from the IR sensor 106 and the IR data is recorded and stored in the memory. Additionally or optionally, the controller 104 may control the speaker 116 to produce a sound and/or the light source 118 to illuminate upon detection of the first portion 32 of the finger in the IR area 108. The controller 104 then determines a pixel coordinate (PosX_{S1}, PosY_{S1}) of the location of the first portion 32 of the finger in the IR area 108 based on the IR data. In some embodiments, the pixel coordinate (PosX_{S1}, PosY_{S1}) may be indicative of a central point of the first portion 32 of the finger in the IR area 108. In other embodiments, the pixel coordinate (PosX_{S1}, PosY_{S1}) may be indicative of any point of the first portion 32 of the finger in the IR area 108.

In response to the detection of the first portion 32 of the finger in the IR area 108, the controller 104 then determines at step 402 of FIG. 6 the position (X_{S1}, Y_{S1}) of the first portion 32 of the finger in relation to the IR device 100, based on the pixel coordinate (PosX_{S1}, PosY_{S1}) derived from the IR data. The position (X_{S1}, Y_{S1}) of the first portion 32 of the finger may be calculated in a similar manner to that described above at step 202 of FIG. 3.

At step 404 of FIG. 6, the controller 104 then detects at least a second portion 34 of the finger in the IR area 304 based on the IR data. In this regard, the controller 104 periodically obtains IR data from the IR sensor 302 and the IR data is recorded and stored in the memory. Additionally or optionally, the controller 104 may control the speaker 116 to produce a sound and/or the light source 118 to illuminate upon detection of the second portion 34 of the finger in the IR area 304. The controller 104 then determines a pixel coordinate (PosX_{S2}, PosY_{S2}) of the location of the second portion 34 of the finger in the IR area 304 based on the IR data. In some embodiments, the pixel coordinate (PosX_{S2}, PosY_{S2}) may be indicative of a central point of the second portion 34 of the finger in the IR area 304. In other embodiments, the pixel coordinate (PosX_{S2}, PosY_{S2}) may be indicative of any point of the second portion 34 of the finger in the IR area 304.

In response to the detection of the second portion 34 of the finger in the IR area 304, the controller 104 then determines at step 406 of FIG. 6 the position (X_{S2}, Y_{S2}) of the second portion 34 of the finger in relation to the IR device 300, based on the pixel coordinate (PosX_{S2}, PosY_{S2}) derived from the IR data. The position (X_{S2}, Y_{S2}) of the second portion 34 of the finger may be calculated in a similar manner to that described above at step 202 of FIG. 3.

Subsequently, at step 408 of FIG. 6, the controller 104 determines a desired point 36 on the graphical user interface shown on the display 24 (see also FIG. 4). In this embodiment, the controller 104 determines the desired point 36 by first calculating a position (X, Y) on the display 24 based on the position (X_{S1}, Y_{S1}) of the first portion 32 of the finger and the position (X_{S2}, Y_{S2}) of the second portion 34 of the finger, as follows:

$$X = {X}_{S 2} - \frac{{D}_{m}}{{D}_{f}} ( {X}_{S 1} - {X}_{S 2} ) \qquad ( 9 )$$

$$Y = {Y}_{S 2} - \frac{{D}_{m}}{{D}_{f}} ( {Y}_{S 1} - {Y}_{S 2} ) \qquad ( 10 )$$

The controller 104 then calculates the desired point position (PosX, PosY) of the desired point 36 on the graphical user interface of the display 24, in the form of a pixel coordinate, based on the position (X, Y), in a similar manner described at step 208 of FIG. 3. At step 410 of FIG. 6, the controller 104 then generates an instruction signal based on the desired point position (PosX, PosY) of the desired point 36 and transmits the instruction signal to the electronic device 20, via the mouse emulator module 114 of the interfacing circuitry 112, to interact with the user interface 22 such that the desired point 36 is emulated on the graphical user interface. It will be appreciated that the electronic device 20 will emulate the desired point 36 on the graphical user interface through known methods based on the instruction signal received from the controller 104.

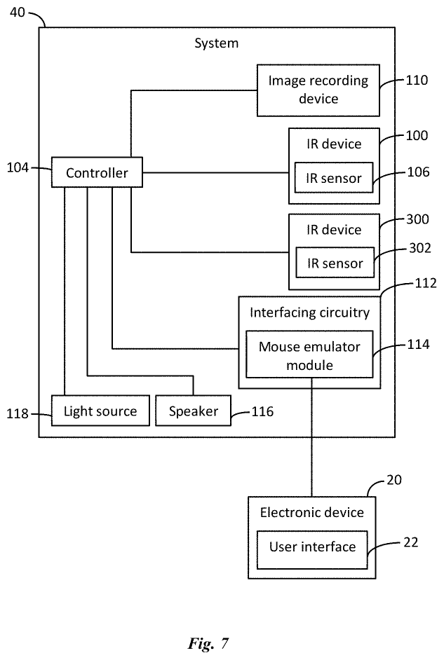

FIG. 7 shows a further embodiment of a system 40 for interacting with a user interface 22 of an electronic device 20. The system 40 is a combination of the systems 10, 30 which includes the image recording device 110 and the IR devices 100, 300, and like features have been indicated with like reference numerals.

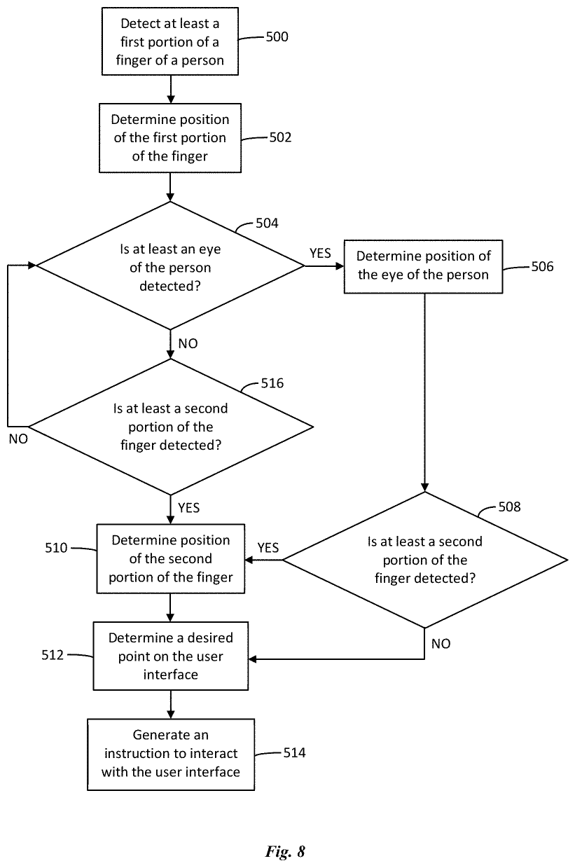

With reference to FIG. 8, the controller 104 of the system 40 is configured to execute instructions to carry out the method operations described hereinafter. The method operations are commenced only when the USB connector of the interfacing circuitry 112 is connected to the USB port of the electronic device 20. It will also be appreciated that the IR devices 100, 300 and the image recording device 110 will be fixed in relation to the electronic device 20 when the IR devices 100, 300 are attached to the electronic device 20.

The method begins at step 500 of FIG. 8, in which the controller 104 detects at least a first portion 32 of a finger of a person in the IR area 108 based on the IR data. In this regard, the controller 104 periodically obtains IR data from the IR sensor 106 and the IR data is recorded and stored in the memory. Additionally or optionally, the controller 104 may control the speaker 116 to produce a sound and/or the light source 118 to illuminate upon detection of the first portion 32 of the finger in the IR area 108. The controller 104 then determines a pixel coordinate (PosX_{S1}, PosY_{S1}) of the location of the first portion 32 of the finger in the IR area 10 based on the IR data.

In response to the detection of the first portion 32 of the finger in the IR area 108, the controller 104 then determines at step 502 of FIG. 8 the position (X_{S1}, Y_{S1}) of the first portion 32 of the finger in relation to the IR device 100, based on the pixel coordinate (PosX_{S1}, PosY_{S1}) derived from the IR data. The position (X_{S1}, Y_{S1}) of the first portion 32 of the finger may be calculated in a similar manner to that described above at step 202 of FIG. 3.

In response to the determination of the position (X_{S1}, Y_{S1}) of the first portion 32 of the finger in relation to the IR device 100, the controller 104 then detects at least an eye of the person in the image area based on the image data. In this regard, the controller 104 periodically obtains image data from the image recording device 110 and the image data is recorded and stored in the memory.

If, at step 504 of FIG. 8, the eye of the person is identified, the controller 104 then determines a pixel coordinate (PosX_{E}, PosY_{E}) of the location of the eye in the image area based on the obtained image data. In response to the detection of the eye of the person, the controller 104 determines at step 506 of FIG. 8 the position of the eye in relation to the image recording device 110, based on the pixel coordinate (PosX_{E}, PosY_{E}) derived from the image data. The position of the eye may be calculated in a similar manner described above at step 206 of FIG. 3.

In response to the determination of the position of the eye, the controller 104 then detects at least a second portion 34 of the finger in the IR area 304 based on the IR data. In this regard, the controller 104 periodically obtains IR data from the IR sensor 302 and the IR data is recorded and stored in the memory. Additionally or optionally, the controller 104 may control the speaker 116 to produce a sound and/or the light source 118 to illuminate upon detection of the second portion 34 of the finger in the IR area 304.

If, at step 508 of FIG. 8, the second portion 34 of the finger in the IR area is detected, the controller 104 then determines a pixel coordinate (PosX_{S2}, PosY_{S2}) of the location of the second portion 34 of the finger in the IR area 304 based on the IR data. In response to the detection of the second portion 34 of the finger in the IR area 304, the controller 104 then determines at step 510 of FIG. 8 the position (X_{S2}, Y_{S2}) of the second portion 34 of the finger in relation to the IR device 300, based on the pixel coordinate (PosX_{S2}, PosY_{S2}) derived from the IR data, in a similar manner to that described above.

Subsequently, at step 512 of FIG. 8, the controller 104 determines a desired point on the graphical user interface shown on the display 24 by calculating a position (X, Y) on the display 24 based on the position (X_{S1}, Y_{S1}) of the first portion 32 of the finger, the position (X_{S2}, Y_{S2}) of the second portion 34 of the finger, and the position (X_{E}, Y_{E}) of the eye, and then calculating the desired point position (PosX, PosY) of the desired point on the graphical user interface of the display, in the form of a pixel coordinate, based on the position (X, Y), in a similar manner described above. At step 514 of FIG. 8, the controller 104 then generates an instruction signal based on the desired point position (PosX, PosY) of the desired point and transmits the instruction signal to the electronic device 20, via the mouse emulator module 114 of the interfacing circuitry 112, to interact with the user interface 22 such that the desired point is emulated on the graphical user interface. It will be appreciated that the electronic device 20 will emulate the desired point on the graphical user interface through known methods based on the instruction signal received from the controller 104.

If, at step 508 of FIG. 8, the second portion 34 of the finger in the IR area 304 is not detected, the controller 104 then determines at step 512 of FIG. 8 a desired point on the graphical user interface shown on the display 24 by calculating a position (X, Y) on the user interface 22 based on the position (X_{S1}, Y_{S1}) of the portion 12 of the finger and the position (X_{E}, Y_{E}) of the eye, and then calculating the desired point position (PosX, PosY) of the desired point on the graphical user interface, in the form of a pixel coordinate, based on the position (X, Y), in a similar manner described above. At step 514 of FIG. 8, the controller 104 then generates an instruction signal based on the desired point position (PosX, PosY) of the desired point and transmits the instruction signal to the electronic device 20, via the mouse emulator module 114 of the interfacing circuitry 112, to interact with the user interface 22 such that the desired point is emulated on the graphical user interface. It will be appreciated that the electronic device 20 will emulate the desired point on the graphical user interface through known methods based on the instruction signal received from the controller 104.

If, at step 504 of FIG. 8, the eye of the person is not identified, the controller 104 then detects at least a second portion 34 of the finger in the IR area 304 based on the IR data. In this regard, the controller 104 periodically obtains IR data from the IR sensor 302 and the IR data is recorded and stored in the memory. Additionally or optionally, the controller 104 may control the speaker 116 to produce a sound and/or the light source 118 to illuminate upon detection of the second portion 34 of the finger in the IR area 304.

If, at step 516 of FIG. 8, the second portion of the finger in the IR area is detected, the controller 104 then determines a pixel coordinate (PosX_{S2}, PosY_{S2}) of the location of the second portion 34 of the finger in the IR area 304 based on the IR data. In response to the detection of the second portion 34 of the finger in the IR area 304, the controller 104 then determines at step 510 of FIG. 8 the position (X_{S2}, Y_{S2}) of the second portion 34 of the finger in relation to the IR device 300, based on the pixel coordinate (PosX_{S2}, PosY_{S2}) derived from the IR data, in a similar manner to that described above.

Subsequently, at step 512 of FIG. 8, the controller 104 determines a desired point on the graphical user interface shown on the display 24 by calculating a position (X, Y) on the display 24 based on the position (X_{S1}, Y_{S1}) of the first portion 32 of the finger and the position (X_{S2}, Y_{S2}) of the second portion 34 of the finger, and then calculating the desired point position (PosX, PosY) of the desired point on the graphical user interface of the display 24, in the form of a pixel coordinate, based on the position (X, Y), in a similar manner described above. At step 514 of FIG. 8, the controller 104 then generates an instruction signal based on the desired point position (PosX, PosY) of the desired point and transmits the instruction signal to the electronic device 20, via the mouse emulator module 114 of the interfacing circuitry 112, to interact with the user interface 22 such that the desired point is emulated on the graphical user interface. It will be appreciated that the electronic device 20 will emulate the desired point on the graphical user interface through known methods based on the instruction signal received from the controller 104.

If, at step 516 of FIG. 8, the second portion 34 of the finger in the IR area 304 is not detected, the controller 104 then reverts to step 504 of FIG. 8 to detect at least an eye of the person in the image area based on the image data.

In other embodiments, the electronic device may be in the form of a laptop computer, a tablet device, a point-of-sale device, a self-service kiosk, an automated teller machine (ATM), self-checkout device, a vending machine, an EFPOS device, or any other device of the type that is configured to allow a user to interact therewith through a touch screen user interface.

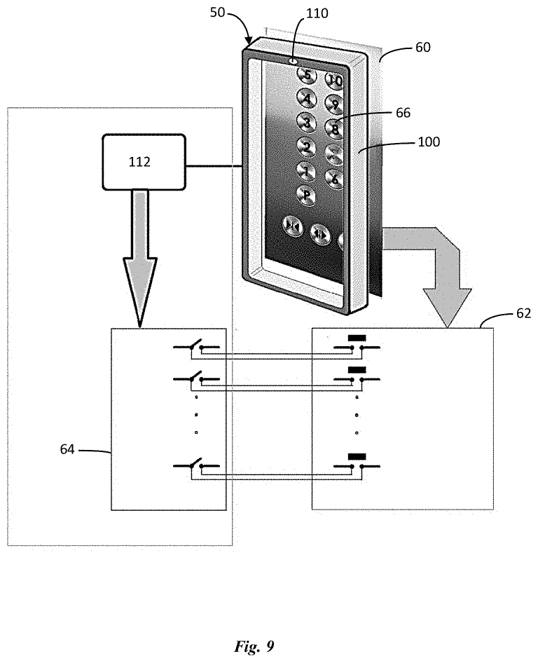

In other embodiments, the electronic device may be in the form of a pedestrian crossing push button, an elevator push button, or any other electronic device of the type that is configured to allow a user to interact therewith through a push button user interface. FIG. 9 shows an embodiment of a system 50 connected to an elevator push button. The system 50 may have similar components and functionality as the system 10 and like features have been indicated with like reference numerals. However, in this embodiment, the interfacing circuitry 112 of the system 50 is connect directly to the circuitry 62 of a push button panel 60 via a relay board 64 for routing instructions from the controller 104 to the push button panel 60. It will be appreciated that the controller 104 of the system 50 may be configured to execute instructions to carry out any of the above method operations in a similar manner. In this regard, the controller 104 determines a desired point corresponding to a button 66 on the push button panel 60 that the user is pointing to, and generates and transmits an instruction, in the form of an electrical signal, to the push button panel 60 to interact therewith such that the desired point is registered on the push button panel 60. In alternative embodiments, the system 50 may have similar components and functionality as the system 30 or the system 40 and the controller 104 of the system 50 may be configured to execute instructions to carry out any of the above method operations in a similar manner.

In some embodiments, the electronic device may be of the type that does not allow communication with the controller of the system, either through a USB connection or via direct electrical connection as described above. However, the electronic device may be provided with a keypad for allowing user interaction therewith, such as a keypad of an ATM, for example.

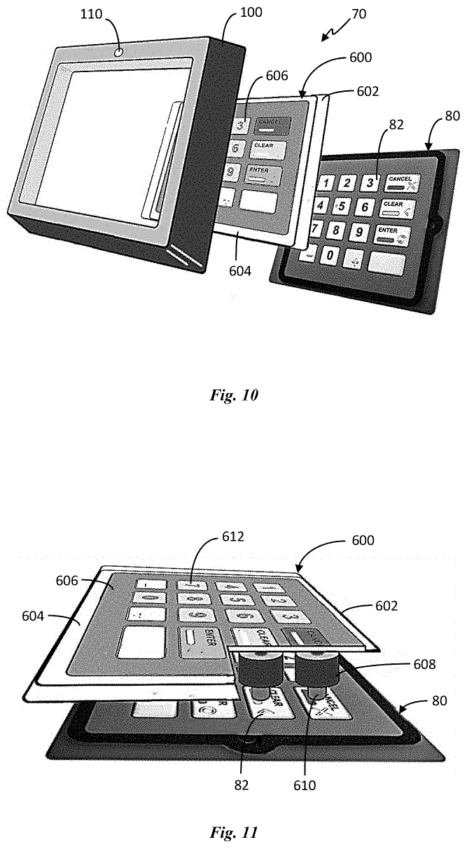

FIGS. 10 and 11 show an embodiment of a system 70 for interacting with a keypad 80 of an ATM. The keypad 80 has a set of push buttons 82. The system 70 may have similar components and functionality as the system 10 and like features have been indicated with like reference numerals. However, in this embodiment, the system 70 comprises an actuating interface 600 disposed rearwardly of the IR area 108 of the IR frame 100 and configured to be fixedly attached to the keypad 80. The actuating interface 600 comprises a panel 602 having a front surface 604, and a label 606 attached to the front surface 604. The label 606 includes an image of a set of buttons 612 that substantially correspond to the appearance of the push buttons 82 of the keypad 80 and directly overlap with the push buttons 82 when the actuating interface 600 is attached to the keypad 80. The actuating interface 600 also comprises a set of solenoid actuators 608 operatively connected to the controller 104 of the system 70 and is configured to interact with the push buttons 82 of the keypad 80, as shown in FIG. 11. Each of the solenoid actuators 608 is disposed rearwardly of a respective button 612 of the label 606 so as to be operatively associated therewith. Each of the solenoid actuators 608 has a moveable piston 610 that is configured to push against the push buttons 82 of the keypad 80 when the actuating interface 600 is attached to the keypad 80.

It will be appreciated that the controller 104 of the system 70 may be configured to execute instructions to carry out any of the above method operations in a similar manner. In this regard, the controller 104 determines a desired point corresponding to a button 612 on the label 606 and a respective push button 82 of the keypad 80, and generates and transmits an instruction, in the form of an electrical signal, to the solenoid actuator 608 operatively associated with the button 612 to move the piston 610 and push against the corresponding push button 82 of the keypad 80. In alternative embodiments, the system 70 may have similar components and functionality as the system 30 or the system 40 and the controller 104 of the system 70 may be configured to execute instructions to carry out any of the above method operations in a similar manner.

The above described embodiments have numerous advantages. For example, the systems 10, 30, 40, 50 70 eliminate the need for a user to touch the display 24 of the electronic device 20 during use. This significantly reduces the risk of germs and other causes of infection being placed on the display 24 of the electronic device 20, and the risk of those germs and other causes of infection being transmitted by subsequent users. Further, by eliminating the need for users to contact the display 24 of the electronic device 20, users do not leave marks or fingerprints on the display 24, which may otherwise be exploited by would-be perpetrators. The systems are also easy to use as a user simply points to a desired point on the user interface 22 without any significant change in the normal behaviour of the user. Moreover, the systems 10, 30, 40, 50 70 are configured to be easily connected to the electronic device 20 and may be adapted for a wide range of electronic devices 20. The systems 10, 30, 40, 50 70 are also designed such that they occupy minimal real-estate when attached to the electronic device 20, thus not affecting the user's normal view of the display 24 of the electronic device 20.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for interacting with a user interface of an electronic device, the system comprising:
an image recording device fixed in relation to the electronic device and configured to generate image data of an image area spaced from the user interface;
an infrared device fixed in relation to the electronic device and configured to generate infrared data of an infrared area spaced from the user interface; and
a controller operatively connected to the infrared device and the image recording device, the controller configured to:
detect at least a portion of a finger of a person in the infrared area based on the infrared data;
in response to the detection of the portion of the finger, determine the position of the portion of the finger in relation to the infrared device based on the infrared data;
detect one or two eyes of the person in the image area based on the image data;
in response to the detection of the one or two eyes of the person, determine the position of the one or two eyes in relation to the image recording device based on the image data; and
determine a desired point on the user interface based on the position of the portion of the finger and the position of the one or two eyes; and
generate an instruction to interact with the user interface based on the desired point.

2. The system according to claim 1, wherein the controller is configured to determine the position of the portion of the finger by:
calculating a pixel coordinate of a point of the portion of the finger based on the infrared data; and
calculating the position of the portion of the finger based on the pixel coordinate of the point of the portion of the finger.

3. The system according to claim 2, wherein the controller is configured to determine the position of the one eye by:
calculating a pixel coordinate of a central point of the one eye; and
calculating the position of the one eye based on the pixel coordinate of the central point of the one eye.

4. The system according to claim 3, wherein the controller is configured to determine a desired point on the user interface by:
calculating a position on the user interface based on the position of the portion of the finger and the position of the one eye; and
calculating the desired point, in the form of a pixel coordinate, on the user interface based on the position on the user interface.

5. The system according to claim 2, wherein the controller is configured to determine the position of the two eyes by:
calculating a pixel coordinate of a central point between the two eyes; and
calculating the position of the two eyes based on the pixel coordinate of the central point of the two eyes.

6. The system according to claim 5, wherein the controller is configured to determine a desired point on the user interface by:
calculating a position on the user interface based on the position of the portion of the finger and the position of the two eyes; and
calculating the desired point, in the form of a pixel coordinate, on the user interface based on the position on the user interface.

7. The system according to claim 1, wherein the image recording device is a camera.

8. The system according to claim 1, wherein the infrared device is an infrared touch frame.

9. A method of interacting with a user interface of an electronic device, the method comprising:
detecting at least a portion of a finger of a person in an infrared area spaced from the user interface, based on infrared data generated by an infrared device;
in response to the detection of the portion of the finger, determining the position of the portion of the finger in relation to the infrared device based on the infrared data;
detecting one or two eyes of the person in an image area spaced from the user interface, based on image data generated by an image recording device;
in response to the detection of the one or two eyes of the person, determining the position of the one or two eyes in relation to the image recording device based on the image data;
determining a desired point on the user interface based on the position of the portion of the finger and the position of the one or two eyes; and
generating an instruction to interact with the user interface based on the desired point.

10. The method according to claim 9, wherein determining the position of the portion of the finger comprises:
calculating a pixel coordinate of a point of the portion of the finger based on the infrared data; and
calculating the position of the portion of the finger based on the pixel coordinate of the point of the portion of the finger.

11. The method according to claim 10, wherein determining the position of the one eye comprises:
calculating a pixel coordinate of a central point of the one eye; and
calculating the position of the one eye based on the pixel coordinate of the central point of the one eye.

12. The method according to claim 11, wherein determining a desired point on the user interface comprises:
calculating a position on the user interface based on the position of the portion of the finger and the position of the one eye; and
calculating the desired point, in the form of a pixel coordinate, on the user interface based on the position on the user interface.

13. The method according to claim 10, wherein determining the position of the two eyes comprises:
calculating a pixel coordinate of a central point between the two eyes; and
calculating the position of the two eyes based on the pixel coordinate of the central point of the two eyes.

14. The method according to claim 13, wherein determining a desired point on the user interface comprises:
calculating a position on the user interface based on the position of the portion of the finger and the position of the two eyes; and
calculating the desired point, in the form of a pixel coordinate, on the user interface based on the position on the user interface.

15. A system for interacting with a user interface of an electronic device, the system comprising:
a first infrared device fixed in relation to the electronic device and configured to generate first infrared data of a first infrared area spaced from the user interface;
a second infrared device fixed in relation to the electronic device and configured to generate second infrared data of a second infrared area spaced from the user interface and the first infrared area; and
a controller operatively connected to the first infrared device and the second infrared device, the controller configured to:
detect a first portion of a finger of a person in the first infrared area based on the first infrared data;
in response to the detection of the first portion of the finger, determine the position of the first portion of the finger in relation to the first infrared device based on the first infrared data;
detect a second portion of the finger in the second infrared area based on the second infrared data;
in response to the detection of the second portion of the finger, determine the position of the second portion of the finger in relation to the second infrared device based on the second infrared data;
determine a desired point on the user interface based on the position of the first portion of the finger and the position of the second portion of the finger; and
generate an instruction to interact with the user interface based on the desired point.

16. The system according to claim 15, wherein the controller is configured to determine the position of the first portion of the finger by:
calculating a pixel coordinate of a point of the first portion of the finger based on the infrared data; and
calculating the position of the first portion of the finger based on the pixel coordinate of the point of the first portion of the finger.

17. The system according to claim 16, wherein the controller is configured to determine the position of the second portion of the finger by:
calculating a pixel coordinate of a point of the second portion of the finger based on the infrared data; and
calculating the position of the second portion of the finger based on the pixel coordinate of the point of the second portion of the finger.

18. The system according to claim 17, wherein the controller is configured to determine a desired point on the user interface by:
calculating a position on the user interface based on the position of the first portion of the finger and the position of the second portion of the finger; and
calculating the desired point, in the form of a pixel coordinate, on the user interface based on the position on the user interface.

19. The system according to claim 15, wherein each of the first and second infrared devices is an infrared touch frame.
